(19) United States
(12) Patent Application Publication
(10) Pub. No.: US 2025/0230061 A1
(43) Pub. Date: Jul. 17, 2025

(54) TRAILER CAPABLE OF TREATING PFAS-CONTAMINATED WATER WITH GAC AND/OR RESIN MEDIA

(71) Applicant: Evoqua Water Technologies LLC, Pittsburgh, PA (US)

(72) Inventors: John Lombardo, Plymouth, MA (US); Daniel R. Brooks, Beaver Falls, PA (US); Karen Tarbert, Houston, TX (US); Nick Dohmen, Red Bluff, CA (US); Alexis Adair, Seven Hills, OH (US)

(21) Appl. No.: 18/852,564

(22) PCT Filed: Mar. 31, 2023
(86) PCT No.: PCT/US2023/017075

§ 371 Date: Sep. 30, 2024

Related U.S. Application Data
(60) Provisional application No. 63/326,293, filed on Apr. 1, 2022.

(51) Int. Cl. C02F 1/00; C02F 1/28; C02F 1/42; C02F 101/30; C02F 101/36

(52) U.S. Cl. CPC C02F 1/008; C02F 1/283; C02F 1/42; C02F 2001/422; C02F 2101/301; C02F 2101/36; C02F 2201/008; C02F 2209/02; C02F 2209/03; C02F 2209/40

(57) ABSTRACT

Methods for facilitating the treatment of potable water containing PFAS are disclosed. A water treatment system involving a plurality of vessels including granular activated carbon or ion exchange resin may be configured. The water treatment system may be arranged on a mobile platform, and the mobile platform may be positioned near a source of the potable water containing PFAS.

### CROSS-REFERENCE TO RELATED APPLICATION

This application claims priority to U.S. Provisional Patent Application Ser. No. 63/326,293, filed on Apr. 1, 2022 and titled “POTABLE TRAILER CAPABLE OF TREATING PFAS-CONTAMINATED WATER WITH GAC AND/OR RESIN MEDIA,” the entire disclosure of which is hereby incorporated herein by reference in its entirety for all purposes.

### FIELD OF TECHNOLOGY

Aspects and embodiments disclosed herein are generally related to the removal and elimination of per- and polyfluoroalkyl substances (PFAS) from potable water.

### BACKGROUND

There is rising concern about the presence of various contaminants in municipal wastewater, surface water, drinking water and groundwater. For example, perchlorate ions in water are of concern, as well as PFAS and PFAS precursors, along with a general concern with respect to total organic carbon (TOC).

PFAS are man-made chemicals used in numerous industries. PFAS molecules typically do not break down naturally. As a result, PFAS molecules accumulate in the environment and within the human body. PFAS molecules contaminate food products, commercial, household and workplace products, municipal water, agricultural soil and irrigation water, and even drinking water. PFAS molecules have been shown to cause adverse health effects in humans and animals.

The U.S. Environmental Protection Agency (EPA) has issued a Contaminant Candidate List (CCL 5) which includes PFAS as a broad class inclusive of any PFAS that fits the revised CCL 5 structural definition of per- and polyfluoroalkyl substances (PFAS), namely chemicals that contain at least one of the following three structures:
R—(CF2)-CF(R′)R″, where both the CF2 and CF moieties are saturated carbons, and none of the R groups can be hydrogen.
R—CF2OCF2-R′, where both the CF2 moieties are saturated carbons, and none of the R groups can be hydrogen.
CF3C(CF3)RR′, where all the carbons are saturated, and none of the R groups can be hydrogen.

The EPA's Comptox Database includes a CCL 5 PFAS list of over 10,000 PFAS substances that meet the Final CCL 5 PFAS definition. The EPA has committed to being proactive as emerging PFAS contaminants or contaminant groups continue to be identified and the term PFAS as used herein is intended to be all inclusive in this regard.

### SUMMARY

In accordance with one or more aspects, a method of facilitating treatment of potable water containing per- and polyfluoroalkyl substances (PFAS) is disclosed. The method may involve receiving an analysis of the potable water containing PFAS and configuring a water treatment system based on the analysis for removing PFAS from the potable water containing PFAS, the configured water treatment system comprising a plurality of vessels including granular activated carbon or ion exchange resin. The method may further involve arranging the water treatment system on a mobile platform and positioning the mobile platform near a source of the potable water containing PFAS.

In some aspects, the PFAS may include perfluorooctane sulfonic acid (PFOS) or perfluorooctanoic acid (PFOA).

In some aspects, at least one vessel may comprise granular activated carbon. In other aspects, at least one vessel may comprise ion exchange resin. In some specific non-limiting aspects, at least a first vessel may comprise granular activated carbon and at least a second vessel may comprise ion exchange resin.

In some aspects, at least two vessels may be arranged in series. In other aspects, at least two vessels may be arranged in parallel. In some specific non-limiting aspects, a first group of vessels may be arranged in parallel and a second group of vessels may be arranged in series, wherein the first group of vessels is in fluid communication with the second group of vessels. At least one of the first and second groups of vessels may comprise granular activated carbon. At least one of the first and second groups of vessels may comprise ion exchange resin.

In some aspects, the water treatment system may be further configured based on a target PFAS removal efficiency. The water treatment system may be further configured to target one or more additional contaminants. The water treatment system may be further configured based on a desired throughput level.

In some aspects, the method may further involve providing telemetry on the mobile platform to monitor at least one of temperature, pressure and flow rate. The method may further involve adjusting an operational parameter of the water treatment system in response to data provided via the telemetry. The method may further comprise deploying maintenance in response to data provided via the telemetry. In at least some aspects, maintenance may involve regenerating spent granular activated carbon or replacing spent ion exchange resin.

In some aspects, the method may further comprise predetermining a bed life for at least one vessel on the mobile platform.

In some aspects, the method may further comprise providing instructions for commissioning the water treatment system on the mobile platform. In other aspects, the method may further comprise fluidly connecting the source of potable water containing PFAS to an inlet of the water treatment system.

In some aspects, the method may further comprise providing instructions for sampling a product stream associated with the water treatment system on the mobile platform prior to introducing the product stream to a potable point of use. Instructions may be provided for taking the mobile platform out of service upon exhaustion of at least one vessel.

In some aspects, the method may further involve reconfiguring the water treatment system on the mobile platform in response to an updated analysis of the potable water containing PFAS.

In some aspects, the method may further involve facilitating the sourcing of a permanent water treatment system during deployment of the mobile platform.

In some aspects, the source of potable water containing PFAS may be associated with a municipal water district.

The mobile platform may be positioned near the source of potable water containing PFAS for commissioning without the need for site preparation.

In some aspects, the mobile platform may include at least one pretreatment unit operation. The mobile platform may be substantially winterized.

In some aspects, each vessel may be a substantially identical, dual-purpose vessel configured to house granular activated carbon or ion exchange resin. Each vessel may be constructed and arranged to prevent channeling.

In some aspects, configuring the water treatment system may involve customizing a number, order, arrangement, flow pattern, interconnection and/or content of the plurality of vessels.

In accordance with one or more aspects, a mobile system for treating potable water containing per- and polyfluoroalkyl substances (PFAS). The system may include a mobile platform, and a water treatment system including a plurality of vessels in a predetermined arrangement on the mobile platform, each vessel comprising granular activated carbon or ion exchange resin, the water treatment system having an inlet fluidly connectable to a source of the potable water containing PFAS. The system may further include an adjustable manifold system interconnecting the plurality of vessels in the predetermined arrangement, the manifold system configured to facilitate parallel flow, series flow or a combination thereof among the plurality of vessels. The system may still further include a telemetry system configured to monitor at least one operational parameter of the mobile system.

In some aspects, the predetermined arrangement may include a customized number, order, flow pattern and/or content of the plurality of vessels. The predetermined arrangement of the plurality of vessels may be based on an analysis of the potable water containing PFAS.

In some aspects, two or more vessels may comprise granular activated carbon. In other aspects, two or more vessels may comprise ion exchange resin. In certain non-limiting aspects, at least a first vessel may comprise granular activated carbon and at least a second vessel may comprise ion exchange resin.

In some aspects, at least two vessels may be arranged in series. In other aspects, at least two vessels may be arranged in parallel. In certain non-limiting aspects, a first group of vessels may be arranged in parallel and a second group of vessels may be arranged in series, wherein the first group of vessels is in fluid communication with the second group of vessels. At least one of the first and second groups of vessels may comprise granular activated carbon. At least one of the first and second groups of vessels may comprise ion exchange resin.

In some aspects, the predetermined arrangement may be further configured based on a target PFAS removal efficiency. The predetermined arrangement may be further configured to target one or more additional contaminants. The predetermined arrangement may be further configured based on a desired throughput level.

In some aspects, the telemetry system may be configured to monitor at least one operational parameter of the mobile platform. The telemetry system may be configured to monitor at least one of temperature, pressure and flow rate associated with the plurality of vessels.

In some aspects, the system may be reconfigurable via the adjustable manifold system in response to an updated analysis of the potable water containing PFAS.

In some aspects, the mobile platform may be configured for deployment near the source of potable water containing PFAS without the need for site preparation. The source of potable water containing PFAS may be associated with a municipal water district. The source of potable water containing PFAS may be a primary water treatment facility.

In some aspects, the mobile platform may include at least one pretreatment unit operation. The mobile platform may be substantially winterized.

In some aspects, each vessel may be an identical, dual-purpose vessel configured to house granular activated carbon or ion exchange resin. Each vessel may be constructed and arranged to prevent channeling.

In some aspects, the mobile system is associated with a PFAS removal rate of at least about 99%. The mobile system may be configured to deliver purified water or deionized (DI) water to a potable point of use.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in the various figures is represented by a like numeral. For purposes of clarity, not every component may be labeled in every drawing. In the drawings:

FIG. 1 presents a schematic view of a mobile water treatment system for treating potable water containing PFAS in accordance with one or more embodiments; and

FIG. 2 presents a schematic view of a dual-purpose vessel for use in the disclosed mobile water treatment systems in accordance with one or more embodiments.

### DETAILED DESCRIPTION

In accordance with one or more embodiments, mobile water treatment systems may be deployed to address PFAS and other emerging contaminants in potable water. The deployment may be for emergency and/or temporary use. A water treatment system may be integrated on a mobile platform, such as a trailer. The water treatment system may be highly customized and available for rapid response upon arrival without extensive site preparation when water quality deviates from a target level. The mobile platform, e.g. trailer may be climate controlled for use in a variety of conditions, even those involving harsh environments. The mobile water treatment system may be fluidly connectable directly to a source of potable water for treatment. Optional onboard pretreatment may prevent large particulates from clogging downstream pressurized adsorption vessels. The adsorption vessels may beneficially be media agnostic to allow for flexibility of system design. In preferred embodiments, GAC and/or ion exchange resin may be strategically implemented in the water treatment systems depending on source water chemistry and treatment goals. Remote monitoring capabilities may facilitate system maintenance and operational efficiencies. PFAS and/or other emerging contaminants can be brought down to non-detect levels to meet the needs of customers and communities, such as those of a municipality.

In accordance with one or more embodiments, potable water containing a per- or poly-fluoroalkyl substance (PFAS) may be treated. PFAS are organic compounds consisting of fluorine, carbon and heteroatoms such as oxygen, nitrogen and sulfur. PFAS is a broad class of molecules that further includes polyfluoroalkyl substances. PFAS are carbon chain molecules having carbon-fluorine bonds. Polyfluoroalkyl substances are carbon chain molecules having carbon-fluorine bonds and also carbon-hydrogen bonds. Common PFAS molecules include perfluorooctanoic acid (PFOA), perfluorooctanesulfonic acid (PFOS), and short-chain organofluorine chemical compounds, such as the ammonium salt of hexafluoropropylene oxide dimer acid (HFPO-DA) fluoride (also known as GenX). PFAS molecules typically have a tail with a hydrophobic end and an ionized end. The hydrophobicity of fluorocarbons and extreme electronegativity of fluorine give these and similar compounds unusual properties.

Initially, many of these compounds were used as gases in the fabrication of integrated circuits. The ozone destroying properties of these molecules restricted their use and resulted in methods to prevent their release into the atmosphere. But other PFAS such as fluoro-surfactants have become increasingly popular. PFAS are commonly use as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply. Further, PFAS have been utilized as key ingredients in aqueous film forming foams (AFFFs). AFFFs have been the product of choice for firefighting at military and municipal fire training sites around the world. AFFFs have also been used extensively at oil and gas refineries for both fire training and firefighting exercises. AFFFs work by blanketing spilled oil/fuel, cooling the surface, and preventing re-ignition. PFAS in AFFFs have contaminated the groundwater at many of these sites and refineries, including more than 100 U.S. Air Force sites.

Although used in relatively small amounts, these compounds are readily released into the environment where their extreme hydrophobicity as well as negligible rates of natural decomposition results in environmental persistence and bioaccumulation. It appears as if even low levels of bioaccumulation may lead to serious health consequences for contaminated animals such as human beings, the young being especially susceptible. The environmental effects of these compounds on plants and microbes are as yet largely unknown. Nevertheless, serious efforts to limit the environmental release of PFAS are now commencing.

Systems for supplying purified or deionized (DI) water to a facility or point of use may include fixed treatment apparatus, for example, carbon filtration columns, ion exchange columns, actinic radiation (e.g., ultraviolet light) disinfection apparatus, microfilters, nanofilters or reverse osmosis (RO) filters and associated pumps and monitoring equipment. Upon exhaustion or responsive to scheduled maintenance, service personnel may travel to the facility or point of use to perform maintenance on the fixed treatment apparatus, for example, to replace exhausted ion exchange media in ion exchange columns.

Currently, when a municipal water district is made aware of PFAS in their water, they have a choice to find a separate source of PFAS-free water or to source rental or capital treatment vessels. Securing these vessels can often come with a long-lead time and require preparation onsite (including, in many cases, the placement of a concrete pad able to hold the vessels or a temporary shelter to house the vessels in the winter).

In accordance with one or more embodiments, a trailer or mobile unit solves this problem by providing a ready-to-deploy system for PFAS treatment. Such deployment may be for emergency or temporary use.

In accordance with one or more embodiments, a mobile water treatment system may be deployed to supplement or replace a primary water treatment system. In various embodiments, any potable source of water may be treated, such as those associated with municipalities, military bases and other water producers. Beneficially, flow capacities of up to about 1000 gpm may be accommodated. In at least some embodiments, the mobile system may be enclosed, such as integrated in a trailer that is insulated and/or heated to allow for winterization. Various aspects of the mobile system, e.g. trailer may be designed with potable applications in mind.

In accordance with one or more embodiments, fixed treatment apparatus for supplying potable water, including but not limited to purified or DI water, to a facility or point of use may be supplemented by or replaced by mobile water treatment systems. The mobile water treatment systems may include one or more or all of the requisite treatment apparatus, for example, comprising ion exchange resin and activated carbon used to treat influent water to produce treated water and provide the treated water to the facility, municipality or point of use. The mobile water treatment systems may be in the form of mobile trailers including inlets for receiving water to be treated and outlets for delivering the treated water to the facility or point of use. A number of treatment vessels comprising activated carbon and ion exchange resin may be incorporated as discussed herein. Optional pretreatment may be onboard the mobile platform or instead associated with the primary, fixed or permanent water treatment system.

In accordance with one or more embodiments, the mobile trailer allows for a client to utilize GAC media, IX resin, or a combination of both in numerous configurations in order to achieve the desired PFAS compound removal and the flow rate required for the intended application, e.g. municipality. In at least some embodiments, the source of potable water containing PFAS may be associated with a municipal water district.

In accordance with one or more embodiments, a source of potable water may be tested or analyzed for water quality. The source of potable water may be a product stream of a primary, fixed water treatment system. The test may be performed onsite or offsite, either by a direct operator of the water treatment facility or outsourced to a third-party. The test may evaluate for the presence of PFAS and/or other emerging contaminants. The test may also evaluate other parameters commonly known to those skilled in the art such as but not limited to alkalinity, total organic carbon (TOC) and/or total dissolved solids (TDS). Various detected levels may be compared against applicable water quality standards to determine if existing water treatment protocols require maintenance, adjustment or supplementation.

In some specific non-limiting embodiments, a third-party that conducts the testing may ultimately provide a mobile water treatment system to supplement the primary water treatment system as discussed herein. In other embodiments, a testing lab may be independent of any system provider. The system provider may receive an analysis report of the potable water to be treated.

In accordance with one or more embodiments, a mobile water treatment system may be customized and configured based on the water analysis to remove PFAS from the potable water containing PFAS. The chemistry of the source of potable water may inform the design. For example, the type and concentration of various PFAS and other target contaminants may impact the system design. One or more treatment goals such as a target PFAS removal efficiency level may also inform the system design. A desired throughput level may further inform the system design. Other considerations may also be factors. For example, the water treatment system may be further configured to target one or more additional contaminants. Table 1 presents a non-limiting list of potential contaminants and the type of adsorption media that may be considered effective for its removal.

TABLE 1

| | |
|---|---|
| PFAS | GAC or IX |
| 1,4 Dioxane | GAC or IX |
| TCE | GAC |
| PCE | GAC |
| TOC | GAC |
| TrihaloMethanes | GAC |
| haloacetic acids | GAC |
| Chromate | IX |
| Decolorization | GAC |
| 123 TCP | GAC |
| Perchlorate | IX |
| Geosmin, MIB | GAC |
| (Taste & Odor) | |
| PAH | |
| Uranium | IX |

In accordance with one or more embodiments, a configured water treatment system may generally include a plurality of treatment vessels, such as adsorption vessels, e.g. pressurized adsorption vessels. The vessels may include adsorption media, such as granular activated carbon or ion exchange resin. In some embodiments, at least one vessel may house granular activated carbon. In other embodiments, at least one vessel may house ion exchange resin. In some specific non-limiting aspects, at least a first vessel may house granular activated carbon and at least a second vessel may house ion exchange resin. Various orders and combinations of adsorption media are contemplated depending on the requirements of an intended treatment application. Those skilled in the art will recognize the types of adsorption media most appropriate for target constituents. In some embodiments, mixed media beds may be implemented. For example, a single vessel may contain a mixture or staging of ion exchange resins.

In accordance with one or more embodiments, at least two vessels may be arranged in series, e.g. a lead/lag arrangement. In other embodiments, at least two vessels may be arranged in parallel. In some specific non-limiting embodiments, a first group of vessels may be arranged in parallel and a second group of vessels may be arranged in series. The first group of vessels may be in fluid communication with the second group of vessels. At least one of the first and second groups of vessels may house granular activated carbon. At least one of the first and second groups of vessels may house ion exchange resin. Various arrangements and flow patterns are contemplated depending on the requirements of an intended treatment application.

In accordance with one or more embodiments, the various vessels of the plurality of vessels may be a substantially identical to facilitate system design. For example, the vessels may be dual-purpose vessels configured to house granular activated carbon or ion exchange resin. In this way, the vessels may be considered media agnostic. Each vessel may be constructed and arranged to prevent channeling. Non-limiting embodiments of the vessels are disclosed further herein.

In accordance with one or more embodiments, designing or configuring the water treatment system may involve customizing a number, order, arrangement, flow pattern, interconnection and/or content of the plurality of vessels. The mobile system may include manifolding with piping and an arrangement of valves to facilitate flexible system design. In this way, an established water treatment system may be reconfigured on the mobile platform in response to an updated analysis of potable water containing PFAS.

In accordance with one or more embodiments, the water treatment system may be arranged on a mobile platform and the mobile platform may be positioned near a source of potable water containing PFAS to be treated. The mobile platform may be positioned near the source of potable water containing PFAS for commissioning without the need for extensive site preparation.

In accordance with one or more non-limiting embodiments, a provider of a mobile water treatment system may setup a lab or pilot to test a proposed treatment system prior to onsite deployment if time permits.

In accordance with one or more embodiments, telemetry on the mobile platform may be provided to monitor various operational parameters. For example, at least one of temperature, pressure and flow rate associated with the trailer and/or vessels may be monitored. An operational parameter of the trailer or water treatment system may be adjusted in response to data provided via the telemetry. In some embodiments, maintenance may be deployed in response to data provided via the telemetry. In at least some embodiments, maintenance may involve regenerating spent granular activated carbon or replacing spent ion exchange resin. The telemetry may generally help reduce system downtime.

In accordance with one or more embodiments, a bed life for at least one vessel on the mobile platform may be predetermined to facilitate system maintenance. Instructions may be provided for taking the mobile platform out of service upon exhaustion of at least one vessel. A supplier of the water treatment system may remove spent media and provide new media. Alternatively, removal of spent media may be the responsibility of the system operator and the supplier of the mobile water treatment system may optionally provide new media.

In accordance with one or more embodiments, instructions may be provided for commissioning the water treatment system on the mobile platform. In other embodiments, a supplier of the mobile water treatment system may fluidly connect the source of potable water containing PFAS to an inlet of the water treatment system.

In accordance with one or more embodiments, a product stream associated with the water treatment system on the mobile platform may be sampled for testing prior to introducing the product stream to a potable point of use. Such testing may be a prerequisite for delivering the product stream for use. Instructions for such sampling may be provided by the provider of the mobile system.

In accordance with one or more embodiments, a provider of the mobile water treatment system may facilitate the sourcing of a permanent water treatment system during deployment of the mobile platform.

In accordance with one or more embodiments, the mobile platform may optionally include at least one pretreatment unit operation. For example, bag filters may capture large solids to prevent clogging of downstream adsorption vessels. In this way, pretreatment may address total suspended solids (TSS). In at least some embodiments, pretreatment unit operations may already be onsite associated with a primary, fixed water treatment system to be supplemented by the mobile systems.

In accordance with one or more embodiments, a mobile platform may be enclosed, insulated and/or substantially winterized to allow for operation in a variety of environments. For example, a mobile trailer may be heated otherwise temperature controlled. Various design aspects of a mobile platform may be specifically tailored for use in potable applications.

In accordance with one or more embodiments, manifolding may facilitate various flow arrangements of parallel, series (lag/lead) and hybrids thereof. Manifolding may also facilitate backwash and/or forward flushing of one or more unit operations. Periodic maintenance may involve taking one or more unit operations temporarily offline for backwash or flushing. Piping may bring utility water and/or air to various unit operations for such maintenance. Any onboard prefilters, such as bag filters, may be periodically replaced. Likewise, spent adsorption media associated with one or more unit operations may be periodically replaced, replenished, reactivated or regenerated. Telemetry as discussed herein may at least in part inform maintenance decisions.

In accordance with one or more embodiments, spikes and/or the presence of anomalous potable water constituents may require review and/or modification of the mobile system design. Site conditions and actual water quality may dictate any bag filter and/or media change-out frequency. Additional inorganic data (TDS, alkalinity, etc.) may be evaluated as well to determine the scale potential of the potable water. It is possible that acidification upstream of a resin bed may be required to reduce scaling potential. Resins may be in the chloride form or the bicarbonate form. It may be desirable to install chloride form resin if the effluent will be above pH 7 in approximately 100BSs. Chlorine in the feed may require use of NSF-61 approved chemicals or GAC as exposure of resin to chlorine is generally not acceptable.

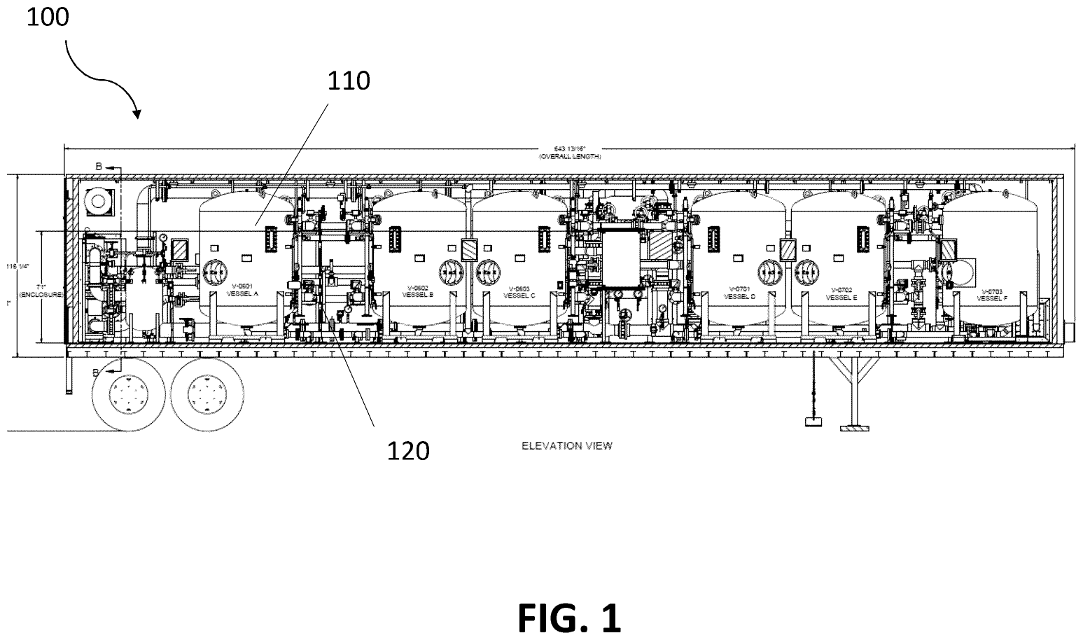

Referring to FIG. 1, a mobile water treatment system 100 is illustrated. The system 100 comprises a plurality of adsorption media vessels 110. The configuration of the water treatment system 100 may involve customizing a number, order, arrangement, flow pattern, interconnection and/or content of the plurality of vessels 110. System design may be based on one or more of a water analysis, product quality target (such as but not limited to PFAS removal efficiency) and/or throughput level as described herein. Flexible manifolding 120 may facilitate customization and/or reconfiguration. Vessels 110 may selectively contain either ion exchange resin or granulated activated carbon. The vessels can be configured to accept both types of media.

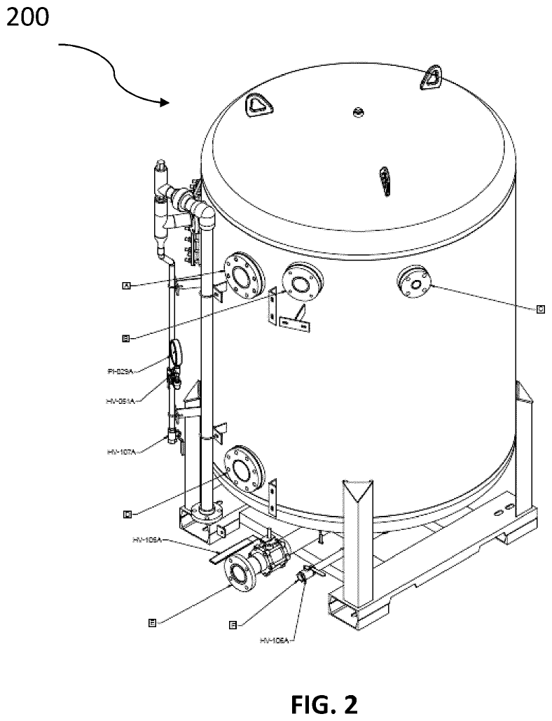

FIG. 2 presents a non-limiting schematic of such a media vessel 200. U.S. Patent Application Publication No. 2022/0324724 which is hereby incorporated herein by reference in entirety for all purposes and is commonly owned with the present Applicant discloses a vessel or column that can accept either ion exchange resin or granulated activated carbon.

In accordance with one or more embodiments, a pressurized media vessel may be capable of effectively containing either granulated activated carbon (GAC) or ion exchange (IX) resin media. A flanged inlet may be configured to introduce process water to the vessel for treatment. The flanged inlet may be configured to removably receive a first distributor constructed and arranged to distribute the process water to a GAC bed housed within the vessel in a first mode of operation, and a second distributor constructed and arranged to distribute the process water to an ion exchange (IX) resin media bed within the vessel in a second mode of operation. The distributors may be specifically designed for the different types of adsorption media, for example, such as to prevent channeling.

In accordance with one or more embodiments, the vessel may house a GAC bed in the first mode of operation, and the vessel may house an IX resin media bed in the second mode of operation. The first distributor may be a single point distributor. The second distributor may be a multi-point distributor. For example, the second distributor may be a four-point distributor.

In some aspects, the vessel may comprise at least one sample port. For example, the first vessel may comprise four sample ports.

In accordance with one or more embodiments, a desired mode of operation may be selected based on the process water analysis. A first mode of operation may involve treating process water with granulated activated carbon (GAC) media and a second mode of operation may involve treating process water with ion exchange (IX) resin media. Each pressurized vessel may be selectively filled with GAC or IX resin media depending on the desired mode of operation. Likewise, a first or second distributor may be selectively attached to a flanged inlet of the pressurized vessel depending on the desired mode of operation, such as to prevent channeling. A source of the process water may be fluidly connected to the flanged inlet of the pressurized vessel for treatment.

In accordance with some embodiments, a first mode of operation may be selected when analyzed process water contains long-chain PFAS, and the second mode of operation may be selected when the analyzed process water contains short-chain PFAS.

In accordance with one or more embodiments, the plurality of vessels can be configured to operate in parallel. In other embodiments, the vessels can be configured to operate in series. In still further embodiments, the vessels can be configured so that all possible combinations or series and parallel operation are possible. For example, vessels A through C can be configured to operate in series. The effluent from these vessels can be fluidly connected to each of vessels D through F which are operating in parallel. This example is non-limiting. The various configurations provide flexibility depending on the concentration of PFAS compounds found in the feed water, on the flow rate desired and also the time between exchange or regeneration required. In some embodiments, once the various medias on the mobile unit reach their capacity, the mobile unit is replaced with another mobile unit with fresh media. In other embodiments, media may be selectively replaced onsite without substituting the entire mobile unit. Various valve positions required to achieve the desired flow configuration may be enabled via manifolding.

It may be desirable to have flexibility in terms of what type of approach is used for treating water containing PFAS. For example, the source and/or constituents of the process water to be treated may be a relevant factor. The properties of PFAS compounds may vary widely. Various federal, state and/or municipal regulations may also be factors. The U.S. Environmental Protection Agency (EPA) developed revised guidelines in May 2016 of a combined lifetime exposure of 70 parts per trillion (PPT) for PFOS and PFOA. In June 2022, this EPA guidance was tightened to a recommendation of 0.004 ppt lifetime exposure for PFOA and 0.02 ppt lifetime exposure for PFOS. Federal, state, and/or private bodies may also issue relevant regulations. Market conditions may also be a controlling factor. These factors may be variable and therefore a preferred water treatment approach may change over time.

Use of various adsorption media is one technique for treating water containing PFAS. Activated carbon and ion exchange resin are both examples of adsorption media that may be used to capture PFAS from water to be treated. Other adsorption media may also be implemented. Such techniques may be used alone or in conjunction.

Conventional activated carbon adsorption systems and methods to remove PFAS from water have shown to be effective on the longer alkyl chain PFAS but have reduced bed lives when treating shorter alkyl chain compounds. Activated carbon treated with a surfactant can have increased bed life. Some conventional anion selective exchange resins have also shown to be effective on the longer alkyl chain PFAS but have reduced bed lives when treating shorter alkyl chain compounds.

Membrane processes such as nanofiltration and reverse osmosis have been used for PFAS removal. Normal oxidative processes have heretofore been unsuccessful in oxidizing PFAS. Even ozone has been reported to be an ineffective oxidant. There have been reports of PFAS moieties being destroyed by combined oxidative technologies such as ozone plus UV or use of specialized anodes to selectively oxidize PFAS. Such techniques may be used in conjunction with the various embodiments disclosed herein.

In accordance with one or more embodiments, there is provided systems and methods of treating water containing PFAS. The water may generally be potable water. The potable water may contain any detectable amount of PFAS. The amount of PFAS may generally exceed a water quality standard and require remediation. In some specific non-limiting embodiments, the water may contain at least 10 ppt PFAS, for example, at least 1 ppb PFAS. For example, the waste stream may contain at least 10 ppt-1 ppb PFAS, at least 1 ppb-10 ppm PFAS, at least 1 ppb-10 ppb PFAS, at least 1 ppb-1 ppm PFAS, or at least 1 ppm-10 ppm PFAS.

In certain embodiments, the water to be treated may include PFAS with other organic contaminants. One issue with treating PFAS compounds in water is that the other organic contaminants compete with the various processes to remove PFAS. For example, if the level of PFAS is 80 ppb and the background total organic carbon (TOC) is 50 ppm, a conventional PFAS removal treatment, such as an activated carbon column, may exhaust very quickly. Thus, it may be important to remove TOC prior to treatment to remove PFAS.

Thus, in some embodiments, the systems and methods disclosed herein may be used to remove background TOC prior to treating the water for removal of PFAS. The methods may be useful for oxidizing target organic alkanes, alcohols, ketones, aldehydes, acids, or others in the water. In some embodiments, the water containing PFAS further may contain at least 1 ppm TOC. For example, the water containing PFAS may contain at least 1 ppm-10 ppm TOC, at least 10 ppm-50 ppm TOC, at least 50 ppm-100 ppm TOC, or at least 100 ppm-500 ppm TOC.

In accordance with one or more embodiments, adsorption media is used to remove PFAS from water. In some embodiments, the removal material, e.g., adsorption media, used to remove the PFAS can be any suitable removal material, e.g., adsorption media, that can interact with the PFAS in the water to be treated and effectuate its removal, e.g., by being loaded onto the removal material. Carbon-based removal materials, e.g., activated carbon, and resin media are both widely used for the removal of organic and inorganic contaminates from water sources. For example, activated carbon may be used as an adsorbent to treat water. In some embodiments, the activated carbon may be made from bituminous coal, coconut shell, or anthracite coal. The activated carbon may generally be a virgin or a regenerated activated carbon. In some embodiments, the activated carbon may be a modified activated carbon. The activated carbon may be present in various forms, i.e., a granular activated carbon (GAC) or a powdered activated carbon (PAC).

In accordance with one or more embodiments, GAC may refer to a porous adsorbent particulate material, produced by heating organic matter, such as coal, wood, coconut shell, lignin or synthetic hydrocarbons, in the absence of air, characterized that the generally the granules or characteristic size of the particles are retained by a screen of 50 mesh (50 screen openings per inch in each orthogonal direction). Without wishing to be bound by any particular theory, PAC typically has a larger surface area for adsorption that GAC and can be agitated and flowed more easily, increasing its effective use.

In some embodiments, the GAC used for adsorption removal of PFAS may be modified to enhance its ability to remove negatively charged species from water, such as deprotonated PFAS. For example, the GAC may be coated in a positively charged surfactant that preferentially interacts with the negatively charged PFAS in solution. The positively charged surfactant maybe a quaternary ammonium-based surfactant, such as cetyltrimethylammonium chloride (CTAC). Various activated carbon media for water treatment are known to those of ordinary skill in the art. In at least some non-limiting embodiments, the media may be an activated carbon as described in U.S. Pat. Nos. 8,932,984 and/or 9,914,110, both commonly owned with the present Applicant, the entire disclosure of each of which is hereby incorporated herein by reference in its entirety for all purposes.

Ion exchange resins are synthetic polymeric beads or granules that contain charged sites that can attract, from a solution, ions of the opposite charge, in order to remove or concentrate impurities. Small resin beads are used for ion exchange. Selective anion exchange resins may have high affinity for anionic contaminants. The resin removes the contaminants from the water and replaces them with harmless anions. Various applicable ion exchange resins including anion exchange resins are commonly known to those skilled in the art and can be selected for based on target constituents for treatment.

In certain non-limiting embodiments, this disclosure describes water treatment systems for removing PFAS from water and methods of treating water containing PFAS. Systems described herein include a contact reactor containing a removal material, e.g., an adsorption media, that has an inlet fluidly connected to a source of water containing PFAS. The removal material, after being exposed to PFAS and removing it from the water, may become loaded with PFAS. Treated water, i.e., water containing a lower concentration of PFAS than the source water may be separated from the removal material, e.g., adsorption media. The contact reactor may then be placed into a cleaning or maintenance mode for further processing of the loaded adsorption media. In accordance with one or more embodiments, loaded adsorption media, e.g. granular activated carbon (GAC) or ion exchange resin, may be disposed of or further processed (reactivated or regenerated).

In some embodiments, the type or dosage of adsorption media may be adjusted based on at least one quality parameter of the potable water to be treated. For example, the at least one quality parameter may include a target concentration of the PFAS in the treated water to be at or below a specified regulatory threshold.

In some embodiments, a source of potable water containing PFAS may be concentrated prior to processing. In other embodiments, it may be processed directly.

In accordance with one or more embodiments, the treated water produced by the mobile system downstream of the adsorption vessels may be substantially free of the PFAS. The treated water being “substantially free” of the PFAS may have at least 90% less PFAS by volume than the waste stream. The treated water being substantially free of the PFAS may have at least 92% less, at least 95% less, at least 98% less, at least 99% less, at least 99.9% less, or at least 99.99% less PFAS by volume than the waste stream. Thus, in some embodiments, the systems and methods disclosed herein may be employed to remove at least 90% of PFAS by volume from the source of water. The systems and methods disclosed herein may remove at least 92%, at least 95%, at least 98%, at least 99%, at least 99.9%, or at least 99.99% of PFAS by volume from the source of water. In certain embodiments, the systems and methods disclosed herein are associated with a PFAS removal rate of at least about 99%, e.g., about 99%, about 99.1%, about 99.2%, about 99.3%, about 99.4%, about 99.5%, about 99.6%, about 99.7%, about 99.8%, about 99.9%, about 99.95%, or about 99.99%.

In some embodiments, systems and methods disclosed herein can be designed for mobile applications via transportation to a site. Mobile systems can be used for emergency or temporary applications, such as in areas of low loading requirement where temporary structures are adequate. A mobile unit may be sized to be transported by a semi-truck to a desired location or confined within a smaller enclosed space such as a trailer, e.g., a standard 53′ trailer, or a shipping container, e.g., a standard 20′ or 40′ intermodal container. Beneficially, material containing PFAS need not be transported across a relatively far distance in accordance with various embodiments. Localized removal and destruction is enabled herein.

In accordance with one or more embodiments, an overall water treatment system may include a primary, fixed water treatment system in combination with a supplemental mobile water treatment system for PFAS remediation as described herein.

The function and advantages of these and other embodiments can be better understood from the following example. This example is intended to be illustrative in nature and is not considered to be in any way limiting the scope of the invention.

### Prophetic Example

A mobile water treatment system will be shipped on an insulated and heated trailer to a municipality as a temporary rental. The required system specifications are presented below and will be met.

### Process Information:

| Maximum Operating Pressure | 100 | psig |
|---|---|---|
| Required Standard | potable | |
| Minimum Flow Rate | 200 | gpm |
| Design Flow Rate | 925 | gpm |
| Peak Flow Rate | 1000 | gpm |
| Operational Schedule | 24 hrs./day | 7 days/wk. |
| Daily Volume (avg.) | 1,352,000 | gallons |
| Treatment Duration (min) | 180 | days |

The enclosed trailer will require minimal field assembly and site connections. It can connect directly to a source of potable water for treatment. The influent will run through a customized vessel system with adsorption media chosen specifically in response to the source water chemistry. A summary of the feed water quality is provided below.

### Feed Water Quality Information Across Six Sample Locations:

| | | | | | | | |
|---|---|---|---|---|---|---|---|
| PFBA | | 7.79 | 6.47 | 4.87 | 19.3 | 3.06 | ng/L |
| PFPeA | | | 3.49 | 3.03 | 52.1 | 0.613 | ng/L |
| PFBS | 4.67 | | 3.07 | 1.83 | 18 | 1.38 | ng/L |
| PFHxA | 10.6 | 11.3 | 4.06 | 2.18 | 49 | 0.735 | ng/L |
| PFPeS | | | 0.687 | | 15.9 | 0.125 | ng/L |
| PFHpA | 3.61 | 4.25 | 2.27 | 0.575 | 17.2 | 0.418 | ng/L |
| PFHxS | 22 | 22.5 | 12.8 | 0.562 | | 0.951 | ng/L |
| PFOA | 4.78 | 4.9 | 6.35 | 0.971 | 15.7 | 1.39 | ng/L |
| PFHpS | | 0.533 | 0.215 | | 4.23 | | ng/L |
| PFOS | 24 | 23.7 | 0.783 | 0.811 | | 1.28 | ng/L |
| PFNA | | 0.359 | | | 1.69 | 0.158 | ng/L |
| PFDA | | | | | 0.264 | | ng/L |
| PFPeA | | 5.08 | | | | | ng/L |
| PFPeS | | 3.05 | | | | | ng/L |
| pH | 7.1 | 7.1 | | | | | |

Based on the specific source water chemistry, the non-limiting system will include two bag filters followed by six media vessels, with plumbing and instrumentation. The six vessels will contain a strong base anion exchange resin which has a high PFAS selectivity and which is NSF-61 certified for use in potable applications. The six vessels will all be operated in parallel although other configurations are achievable through manipulation of the system manifolding. This will allow for about 3.6 minutes of empty bed contact time per vessel. Each five foot diameter (eight foot tall) ASME code vessel is designed for 100 psig at 150° F. Each vessel will hold about 75 cu.ft. of ion exchange resin (about 3225 pounds per vessel). The vessels will each include a side access port, inlet and outlet pressure gauges and sample ports.

The mobile trailer will include inline pressure and flow meters, internal plumbing including manifolding and a PLC-based control system to monitor the equipment for pressure and flow.

An initial supply of filter bags and anion exchange resin will be provided, with the media being slurry-filled into the vessels onsite. At the end of the rental, and for any intermediate maintenance, the media will be removed from the vessels via slurry into dewatering boxes. The municipality may be responsible for disposal of spent media and/or filter bags. Water will be drained from tanks and blown down with air. Specifics regarding mobilization, demobilization and any intermediate rebedding will be predetermined. The scope of various civil, mechanical and electrical requirements, as well as related responsibility will also be predetermined.

PFAS will be treated to below applicable PFAS limits or non-detect.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

1.-30. (canceled)

31. A mobile system for treating potable water containing per- and polyfluoroalkyl substances (PFAS), comprising:
a mobile platform;
a water treatment system including a plurality of vessels in a predetermined arrangement on the mobile platform, each vessel comprising granular activated carbon or ion exchange resin, the water treatment system having an inlet fluidly connectable to a source of the potable water containing PFAS;
an adjustable manifold system interconnecting the plurality of vessels in the predetermined arrangement, the manifold system configured to facilitate parallel flow, series flow or a combination thereof among the plurality of vessels; and
a telemetry system configured to monitor at least one operational parameter of the mobile system.

32. The system of claim 31, wherein the predetermined arrangement includes a customized number, order, flow pattern and/or content of the plurality of vessels.

33. The system of claim 32, wherein the predetermined arrangement of the plurality of vessels is based on an analysis of the potable water containing PFAS.

34. The system of claim 31, wherein two or more vessels comprise granular activated carbon.

35. The system of claim 31, wherein two or more vessels comprise ion exchange resin.

36. The system of claim 31, wherein at least a first vessel comprises granular activated carbon and at least a second vessel comprises ion exchange resin.

37. The system of claim 31, wherein at least two vessels are arranged in series.

38. The system of claim 31, wherein at least two vessels are arranged in parallel.

39. The system of claim 38, wherein a first group of vessels are arranged in parallel and a second group of vessels are arranged in series, wherein the first group of vessels is in fluid communication with the second group of vessels.

40. The system of claim 39, wherein at least one of the first and second groups of vessels comprises granular activated carbon.

41. The system of claim 33, wherein the predetermined arrangement is further configured based on a target PFAS removal efficiency.

42. The system of claim 33, wherein the predetermined arrangement is further configured to target one or more additional contaminants.

43. The system of claim 33, wherein the predetermined arrangement is further configured based on a desired throughput level.

44. The system of claim 31, wherein the telemetry system is configured to monitor at least one operational parameter of the mobile platform.

45. The system of claim 31, wherein the telemetry system is configured to monitor at least one of temperature, pressure and flow rate associated with the plurality of vessels.

46. The system of claim 31, wherein the system is reconfigurable via the adjustable manifold system in response to an updated analysis of the potable water containing PFAS.

47. The system of claim 31, wherein the mobile platform is configured for deployment near the source of potable water containing PFAS without the need for site preparation.

48. (canceled)

49. (canceled)

50. The system of claim 31, wherein the mobile platform includes at least one pretreatment unit operation.

51. (canceled)

52. (canceled)

53. (canceled)

54. The system of claim 31, wherein the mobile system is associated with a PFAS removal rate of at least about 99%.

55. The system of claim 54, wherein the mobile system is configured to deliver purified water or deionized (DI) water to a potable point of use.
